(19) United States
(12) Patent Application Publication
(10) Pub. No.: US 2021/0133453 A1
(43) Pub. Date: May 6, 2021

(54) TERMINAL DEVICE, INFORMATION PROCESSING METHOD, AND NON-TRANSITORY STORAGE MEDIUM RECORDING PROGRAM

(71) Applicant: OMRON HEALTHCARE Co., Ltd., Kyoto (JP)

(72) Inventors: Yuki SAKAMOTO, Kyoto (JP); Yoshihito NAKANISHI, Kyoto (JP); Takanobu YAMAUCHI, Kyoto (JP)

(21) Appl. No.: 17/147,031

(22) Filed: Jan. 12, 2021

Related U.S. Application Data
(63) Continuation of application No. PCT/JP2019/026075, filed on Jul. 1, 2019.

(30) Foreign Application Priority Data
Jul. 20, 2018 (JP) 2018-136985

(51) Int. Cl. G06K 9/00; G06F 3/0484; G06F 3/0488; G06F 16/955; G06F 9/451

(52) U.S. Cl. CPC G06K 9/00671; G06F 3/04842; G06F 9/453; G06F 16/9566; G06F 3/0488

(57) ABSTRACT

Terminal device includes a display device, an image capture device that captures an image of an electronic device to generate a captured image, the electronic device being in a state where display content including at least one display element is displayed on a display screen, a presentation image generation unit that generates, based on the captured image, a presentation image corresponding to the display content, a first display control unit that causes the display device to display the presentation image, an input unit receives a user input of selecting a display element in the presentation image, a model information acquisition unit that acquires model information indicating a model of the electronic device, a descriptive information acquisition unit that acquires descriptive information including descriptive text of the display element and associated with the model information, and a second display control unit that causes the display device to display the descriptive text.

### CROSS-REFERENCE TO RELATED APPLICATIONS

This application is the U.S. national stage application filed pursuant to 35 U.S.C. 365(c) and 120 as a continuation of International Patent Application No. PCT/JP2019/026075, filed Jul. 1, 2019, which application claims priority from Japanese Patent Application No. 2018-136985, filed Jul. 20, 2018, which applications are incorporated herein by reference in their entireties.

### TECHNICAL FIELD

The present invention relates to technology that provides, for example, description related to an electronic device to a user.

### BACKGROUND ART

In a case where a user needs to find out about an issue with a device, such as a case where an unknown display element (a pictogram, for example) is displayed on a display screen of the electronic device, a user generally accesses a website associated with the electronic device by using a terminal device such as a smart phone, and refers to an electronic manual (may also be referred to as an operation guide) for the electronic device.

In the method described above, there are many procedures until a user reaches the desired information (for example, descriptive text describing meaning of a pictogram). For example, to access the website, an operation such as a search is necessary. Further, it is necessary to search for the location of the desired information in the electronic manual. Although a keyword search is available in the electronic manual, it is still necessary to input a keyword to perform a search. Additionally, as for a display element such as a pictogram, a user does not know which keyword is to be used to perform a search, and even when the keyword search is available in the electronic manual, a user may have to search several pages for the desired information. Further, to perform a search for reaching a corresponding electronic manual, information such as a correct product name or model may be necessary, and often such information cannot be obtained easily.

For example, Patent Document 1 discloses a terminal device that displays an electronic manual. This terminal device displays an image of a vehicle including a plurality of points, and superimposes a speech bubble indicating an item of a site corresponding to a point tapped by a user on the image to display the speech bubble. Then, in response to the user tapping the speech bubble, the terminal device displays manual information according to the item described above.

### CITATION LIST

### Patent Literature

Patent Document 1: JP 2016-162155 A

### SUMMARY OF INVENTION

### Technical Problem

In Patent Document 1, it is easy to access manual information. However, it is necessary to search manual information for desired information, and a user cannot easily reach the desired information.

The present invention has been made focusing on the above-described circumstances, and an object of the present invention is to provide a terminal device, an information processing method, and a non-transitory storage medium recording a program that enable a user to easily obtain description of a display element displayed in an electronic device.

### Solution to Problem

The present invention adopts the following configurations to solve the above-described problem.

A terminal device according to an aspect includes a display device, an image capture device configured to capture an image of an electronic device to generate a captured image, the electronic device being in a state where display content including at least one display element is displayed on a display screen, a presentation image generation unit configured to generate, based on the captured image, a presentation image corresponding to the display content, a first display control unit configured to cause the display device to display the presentation image, an input unit configured to receive a user input of selecting a display element in the presentation image, a model information acquisition unit configured to acquire model information indicating a model of the electronic device, a descriptive information acquisition unit configured to acquire descriptive information including descriptive text of the display element and associated with the model information, and a second display control unit configured to cause the display device to display the descriptive text.

According to the above-described configuration, when a user captures an image of an electronic device by using the image capture device of the terminal device, the display device of the terminal device displays a presentation image corresponding to display content displayed in the electronic device. Then, when the user selects any of display elements in the presentation image, the display device of the terminal device displays descriptive text of the selected display element. In this way, the user performs a simple operation including image capturing and selection to obtain the description of the display element. Thus, the user can easily obtain the description of the display element displayed in the electronic device.

According to an aspect, the display element may be a pictogram. According to this configuration, even when the display element is a pictogram that is difficult to express by using a keyword, description of the pictogram can be obtained easily.

According to an aspect, the presentation image generation unit may generate, as the presentation image, an image in which the display content is reproduced. According to this configuration, since the display device of the terminal device displays the same image as the display content displayed in the electronic device, a user can intuitively perform an operation of selecting a display element.

According to an aspect, the descriptive information acquisition unit may acquire the descriptive information via the Internet in response to the user input. According to this configuration, the descriptive information is acquired via the Internet immediately before presentation of the descriptive information. Accordingly, the latest descriptive information can be presented to a user.

According to an aspect, the model information acquisition unit may further include a model identification unit configured to identify a model of the electronic device, based on a partial image corresponding to the display content in the captured image, and the descriptive information acquisition unit may acquire the descriptive information associated with the model. According to this configuration, it is not necessary for a user to input model information to the terminal device. Thus, convenience further improves for a user.

According to an aspect, the descriptive information may further include a Uniform Resource Locator (URL) of a Web page associated with the display element, and the second display control unit may cause the display device to further display a hyperlink to the Web page. According to this configuration, a user can easily obtain more detailed description of a display element.

### Advantageous Effects of Invention

According to the present invention, a terminal device, an information processing method, and a non-transitory storage medium recording a program that enable a user to easily obtain description of a display element displayed in an electronic device can be provided.

### BRIEF DESCRIPTION OF DRAWINGS

FIG. 1 is a view illustrating an example of a terminal device according to an embodiment.

FIG. 2 is a view illustrating appearance of a blood pressure monitor according to an embodiment.

FIG. 3 is a block diagram illustrating an example of a hardware configuration of a terminal device according to an embodiment.

FIG. 4 is a block diagram illustrating an example of a software configuration of a terminal device according to an embodiment.

FIG. 5 is a view illustrating an example of an image capture screen displayed in a terminal device according to an embodiment.

FIG. 6 is a view illustrating an example of a selection screen displayed in a terminal device according to an embodiment.

FIG. 7 is a view illustrating an example of a description screen displayed in a terminal device according to an embodiment.

FIG. 8 is a flowchart illustrating an example of an information processing method executed by a terminal device according to an embodiment.

FIG. 9 is a view illustrating an example of a selection screen displayed in a terminal device according to an embodiment.

### DESCRIPTION OF EMBODIMENTS

Hereinafter, embodiments of the present invention will be described with reference to the drawings.

### Application Example

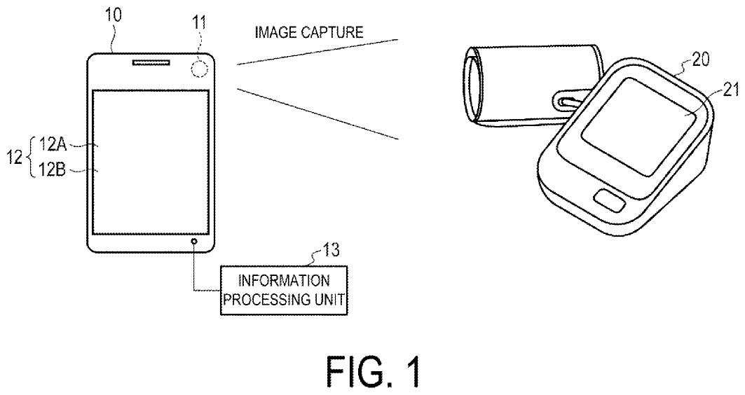

With reference to FIG. 1, an example of a scene to which the present invention is applied will be described. FIG. 1 illustrates an example of a terminal device 10 according to an embodiment. The terminal device 10 is typically a mobile device equipped with a camera 11 and a touch screen 12. The terminal device 10 may be a smart phone, a tablet personal computer (PC), a personal digital assistant (PDA), a mobile phone, or the like.

The terminal device 10 provides operation manual service related to an electronic device. The operation manual service is service of presenting, to a user, descriptive text of a display element (may also be referred to as an item) displayed on a display screen (a screen of a display device) of the electronic device. Here, the display element refers to information in display content displayed on the display screen of the electronic device, and is meaningful as an individual item. For example, a blood pressure monitor 20 that is an example of the electronic device can display the display element such as a measurement value of a systolic blood pressure, a measurement value of diastolic blood pressure, a date, time, a pictogram (may also simply be referred to as a “picto”), an error code, and an error message. The pictogram expresses information by using a pictorial symbol. The error code is a code assigned to a type (content) of error that may occur in the blood pressure monitor 20. For example, a user may not know what a pictogram displayed on a display screen 21 of the blood pressure monitor 20 means, and may wish to know the meaning of the pictogram. In that case, a user can capture an image of the blood pressure monitor 20 by using the camera 11 of the terminal device 10, and accordingly, the user can obtain descriptive text of the pictogram.

The terminal device 10 includes an information processing unit 13 in addition to the camera 11 and the touch screen 12.

The camera 11 captures an image of a target object and generates a captured image. The target object is an electronic device equipped with a display device. The electronic device is a personal or household health device, but is not limited to this. Examples of the health device include a measurement device that measures an indicator related to a human body such as a blood pressure monitor, an electrocardiograph, a scale, a body composition meter, a pedometer, and a sleep monitor, and a treatment device that performs treatment on a human body such as a transcutaneous electrical nerve stimulation (TENS) massage device. Additionally, the electronic device may also be a phone, an audio device, a remote control of an air conditioner, or the like. Additionally, the electronic device may be a device used in a hospital or a factory. In the example illustrated in FIG. 1, the target object is the blood pressure monitor 20 for household. The camera 11 corresponds to an “image capture device” of the present invention.

The touch screen 12 includes a display device 12A and a touch panel 12B provided on a screen (a liquid crystal panel, for example) of the display device 12A. The display device 12A receives image data from the information processing unit 13, and displays an image according to the image data. The touch panel 12B detects a position (a contact position) on the screen at which an object such as a finger comes into contact, and outputs an operation signal indicating the contact position to the information processing unit 13. The information processing unit 13 determines content of an operation performed by a user, based on the image data provided to the display device 12A and the operation signal received from the touch panel 12B.

The information processing unit 13 receives the captured image from the camera 11. Based on the received captured image, the information processing unit 13 generates a presentation image corresponding to the display content displayed on the display screen 21 of the blood pressure monitor 20, and causes the display device 12A to display the presentation image. The presentation image is, for example, an image in which the display content displayed on the display screen 21 of the blood pressure monitor 20 is reproduced. The display content includes at least one display element, and thus, the presentation image includes the at least one display element.

The information processing unit 13 receives an input from a user of selecting a display element in the presentation image, and causes the display device 12A to display descriptive information related to the display element. For example, when a user taps a region on the screen corresponding to any of display elements in a state where the display device 12A displays the presentation image, the information processing unit 13 causes the display device 12A to display descriptive information related to the display element in response to the operation by the user.

As described above, the terminal device 10 according to the present embodiment captures an image of the blood pressure monitor 20 by using the camera 11, presents, to a user, a presentation image corresponding to display content displayed in the blood pressure monitor 20, receives an input from the user of selecting a display element in the presentation image, and presents, to the user, descriptive information related to the display element. Thus, a user performs a simple operation including capturing an image of the blood pressure monitor 20 and selecting a display element, to obtain description of the display element. Thus, a user can easily obtain description of a display element such as a pictogram displayed in the blood pressure monitor 20.

Next, a terminal device according to an embodiment will be described in detail.

### Configuration Example

### Blood Pressure Monitor

First, a blood pressure monitor that is referred to for describing a terminal device according to the present embodiment will be described.

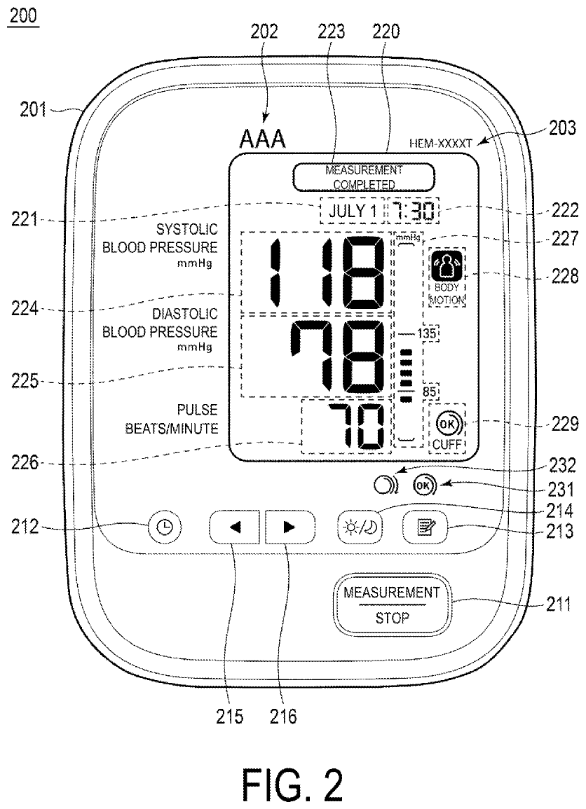

FIG. 2 illustrates appearance of a blood pressure monitor 200 as an electronic device. The blood pressure monitor 200 illustrated in FIG. 2 is an oscillometric blood pressure monitor, and is a stationary blood pressure monitor in which a body 201 and a cuff (an arm band) that is wound around an upper arm of a user are separately provided. Note that, in FIG. 2, for simplicity, the cuff and an air tube that connects the body 201 and the cuff are omitted. Additionally, since the blood pressure monitor 200 may be a generic blood pressure monitor, detailed description of the blood pressure monitor 200 will be omitted.

Brand information 202 indicating a brand (a manufacturer) of the blood pressure monitor 200 and model information 203 indicating a model of the blood pressure monitor 200 are printed in the body 201.

The body 201 includes a plurality of buttons 211 to 216 of a push type as input devices. The button 211 is a button for starting blood pressure measurement. When the button 211 is depressed, the blood pressure monitor 200 is turned on, and the blood pressure monitor 200 starts blood pressure measurement. When the button 211 is depressed during the blood pressure measurement, the blood pressure monitor 200 stops (pauses) the blood pressure measurement. The button 212 is a button for setting a clock. The button 213 is a button for viewing a record (history). The buttons 215 and 216 are used for setting the clock, selecting the record to be viewed, and the like. The button 214 is a button for viewing an average value of each of systolic blood pressure, diastolic blood pressure, and a pulse rate. The average value is, for example, an average of measurement values obtained for the most recent week. When the button 214 is depressed, an average value related to measurement performed in the morning is displayed. When the button 214 is depressed once again, an average value related to measurement performed in the evening is displayed.

The body 201 further includes a display device 220 and lamps 231 and 232. The display device 220 can display a plurality of display elements such as a date, time, a systolic blood pressure value, a diastolic blood pressure value, a pulse rate, blood pressure value level display, a body motion mark, a cuff mark, measurement completion display, and an error code. The body motion mark and the cuff mark are examples of a pictogram. In the example illustrated in FIG. 2, the display device 220 is a segmented liquid crystal display device. Thus, a region (a position) in which each of the display elements is displayed is determined. In FIG. 2, the blood pressure monitor 200 immediately after completion of blood pressure measurement is illustrated, and some of the display elements are not displayed on a screen of the display device 220.

The screen of the display device 220 includes a plurality of regions including regions 221 to 229. The date is displayed in the region 221, and the time is displayed in the region 222. The measurement completion display is displayed in the region 223. The systolic blood pressure value is displayed in the region 224, the diastolic blood pressure value is displayed in the region 225, and the pulse rate is displayed in the region 226. The blood pressure value level display is displayed in the region 227. The blood pressure value level display expresses a condition of blood pressure in 17 stages. The body motion mark is displayed in the region 228. The body motion mark indicates a body motion during measurement. In a case where no body motion is detected during measurement, the body motion mark is not lit. The cuff mark is displayed in the region 229. The cuff mark indicates whether or not the cuff is wound at appropriate intensity. The cuff mark illustrated in FIG. 2 indicates that the cuff is wound at appropriate pressure.

The error code may be displayed in the region 224 and/or the region 226. A plurality of the error codes according to the types of errors that have occurred in the blood pressure monitor 200 are prepared. For example, an error code “E1” indicates that the cuff is not properly connected to the body 201. An error code “E2” indicates that measurement has failed due to a motion of an arm or a body during the measurement. An error code “Er” indicates that the body 201 malfunctions.

When a way of winding the cuff is appropriate, the lamp 231 is lit. When the way of winding the cuff is not appropriate, the lamp 232 is lit.

The blood pressure monitor 200 is not limited to the configuration illustrated in FIG. 2. For example, the display device 220 may be a dot matrix-type display device. Additionally, although it is assumed that the blood pressure monitor 200 does not have a communication function, the blood pressure monitor 200 may include a wireless module such as a Bluetooth (registered trademark) module. The blood pressure monitor 200 may be a wearable blood pressure monitor.

### Terminal Device

### Hardware Configuration

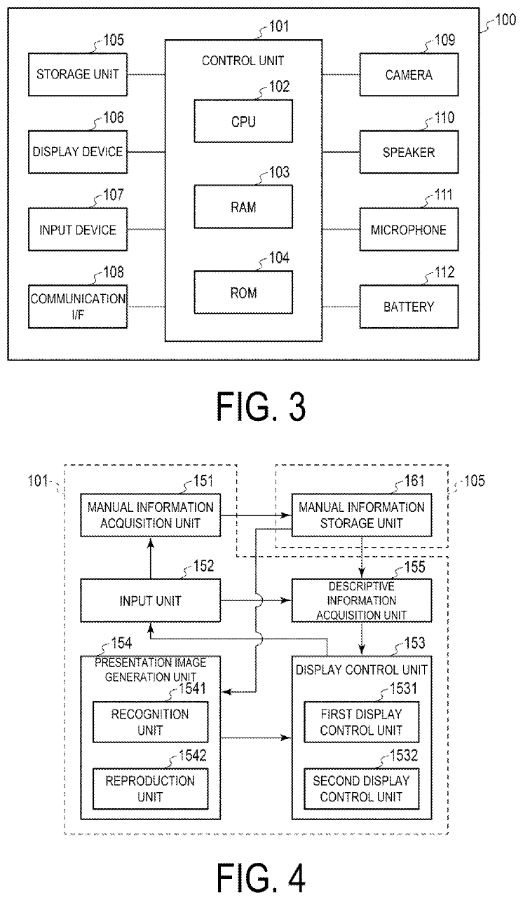

With reference to FIG. 3, an example of a hardware configuration of a terminal device 100 according to an embodiment will be described. In the example illustrated in FIG. 3, the terminal device 100 includes a control unit 101, a storage unit 105, a display device 106, an input device 107, a communication interface 108, a camera 109, a speaker 110, a microphone 111, and a battery 112.

The control unit 101 includes a central processing unit (CPU) 102, a random access memory (RAM) 103, a read only memory (ROM) 104, and the like, and controls each component. The storage unit 105 is, for example, an auxiliary storage device such as a hard disk drive (HDD) and a semiconductor memory (a flash memory, for example), and stores, in a non-transitory manner, a program to be executed by the control unit 101, settings data necessary for executing the program, and the like. A storage medium provided in the storage unit 105 is a medium that accumulates information such as a recorded program by an electrical, magnetic, optical, mechanical, or chemical action such that a computer, other devices and machines, or the like can read the information such as the recorded program. Note that some of the programs may be stored in the ROM 104.

The display device 106 displays information. Specifically, the display device 106 receives image data from the control unit 101, and displays an image according to the received image data. The display device 106 may be a liquid crystal display device or an organic electro-luminescence (EL) display. The organic EL display may also be referred to as an organic light emitting diode (OLED) display.

The input device 107 receives an operation with respect to the terminal device 100 from a user. Typically, the input device 107 includes a touch panel provided on a screen of the display device 106. The touch panel detects a position (a contact position) on the screen of the display device 106 at which an object such as a finger comes into contact, and outputs an operation signal indicating the contact position to the control unit 101. The control unit 101 determines content of an operation performed by a user, based on the image data provided to the display device 106 and the operation signal received from the touch panel. The touch panel can be, for example, a capacitive touch panel. The input device 107 may further include a button of a push type.

The communication interface 108 is an interface for communicating with an external device. The communication interface 108 sends information to or receives information from the external device. The communication interface 108 includes, for example, a wireless module including an antenna. In an example, the communication interface 108 includes a Long Term Evolution (LTE) (registered trademark) module and a Bluetooth module. Accordingly, the terminal device 100 can use the LTE module to communicate with a device such as a Web server via a mobile communication network, or can use the Bluetooth module to directly communicate with other terminal devices owned by a user. Note that the communication interface 108 may include a terminal such as a micro universal serial bus (USB) connector.

The camera 109 captures an image of a target object to generate a captured image, and outputs data of the captured image to the control unit 101. The camera 109 includes, for example, a charge coupled device (CCD) or a complementary metal oxide semiconductor (CMOS) sensor, and an image processing circuit that generates a captured image, based on an output of the CCD or the CMOS sensor. The camera 109 corresponds to the “image capture device” of the present invention. Note that at least a portion of processing performed by the image processing circuit may be performed by the control unit 101. In this case, the “image capture device” of the present invention is realized by the camera 109 and the control unit 101.

The speaker 110 converts an acoustic signal supplied from the control unit 101 into sound. The microphone 111 converts sound into an electrical signal. The microphone 111 enables a user to perform an operation (inputting a character, for example) with respect to the terminal device 100 by using voice.

The battery 112 supplies power to each of the components. The battery 112 is, for example, a rechargeable battery.

Note that, as for a specific hardware configuration of the terminal device 100, components can be omitted, replaced, or added as appropriate according to the embodiments. For example, the control unit 101 may include a plurality of processors.

### Software Configuration

With reference to FIG. 4, an example of a software configuration of the terminal device 100 will be described. In the example illustrated in FIG. 4, the terminal device 100 includes a manual information acquisition unit 151, an input unit 152, a display control unit 153, a presentation image generation unit 154, a descriptive information acquisition unit 155, and a manual information storage unit 161. The manual information acquisition unit 151, the input unit 152, the display control unit 153, the presentation image generation unit 154, and the descriptive information acquisition unit 155 execute the following processing by the control unit 101 of the terminal device 100 executing a program stored in the storage unit 105. When the control unit 101 executes the program, the control unit 101 unfolds the program in the RAM 103. Then, the control unit 101 causes the CPU 102 to interpret and execute the program unfolded in the RAM 103 to control each of the components. The manual information storage unit 161 is realized by the storage unit 105.

The manual information acquisition unit 151 acquires manual information related to the blood pressure monitor 200, and causes the manual information storage unit 161 to store the manual information. The manual information includes descriptive information related to each of the display elements that can be displayed by the blood pressure monitor 200, display position information indicating a position on the display screen at which each of the display elements is displayed, and image data of each of the display elements. The descriptive information related to each of the display elements includes descriptive text of each of the display elements. The descriptive information may further include a Uniform Resource Locator (URL) of a Web page associated with each of the display elements. For example, when a user inputs the model information (HEM-XXXXT, for example) of the blood pressure monitor 200 by using the input device 107, the manual information acquisition unit 151 acquires manual information associated with the model information input, from a server on the Internet via the communication interface 108.

The input unit 152 receives a user input. The user input is, for example, an instruction to execute image capture using the camera 109, an instruction to select a display element, the model information, and the like. For example, the input unit 152 receives an operation signal from the touch panel, receives, from the display control unit 153, display content information indicating content of an image displayed by the display device 106, and identifies content of an instruction input by a user, based on the operation signal and the display content information. The input unit 152 provides the model information to the manual information acquisition unit 151. The input unit 152 provides information indicating a display element selected by a user to the descriptive information acquisition unit 155.

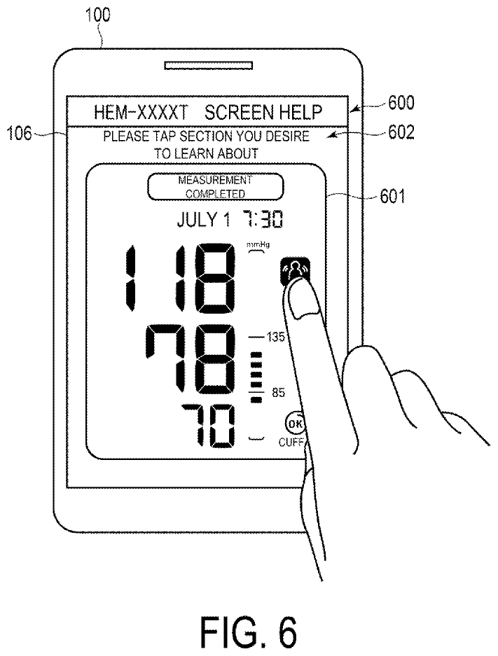

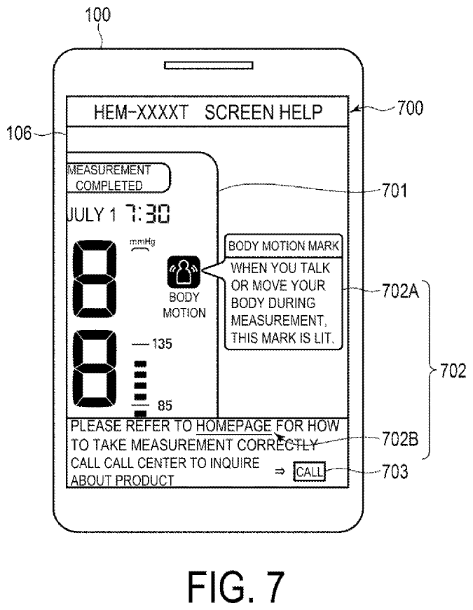

The display control unit 153 controls the display device 106. The display control unit 153 causes the display device 106 to display an image. For example, the display control unit 153 includes a first display control unit 1531 that causes the display device 106 to display a selection screen (a selection screen 600 illustrated in FIG. 6, for example) including the presentation image, and a second display control unit 1532 that causes the display device 106 to display a description screen including the descriptive text (a description screen 700 illustrated in FIG. 7, for example). In an image capture mode in which the camera 109 captures an image, the display control unit 153 may cause the display device 106 to display a guide indicating the range in which the display screen of the blood pressure monitor 200 is to fit. This range corresponds to the recognition range in which recognition by a recognition unit 1541 described below is performed.

The presentation image generation unit 154 receives a captured image from the camera 109, and generates, based on the captured image, a presentation image corresponding to display content displayed on the display screen of the blood pressure monitor 200. In the present embodiment, the presentation image generation unit 154 includes the recognition unit 1541 and a reproduction unit 1542. The recognition unit 1541 recognizes, from the captured image, the content displayed on the display screen of the blood pressure monitor 200. Specifically, the recognition unit 1541 recognizes the display element displayed by the display device 220 of the blood pressure monitor 200, based on the captured image, and the display position information and the image data in the manual information stored in the manual information storage unit 161. For example, the recognition unit 1541 defines, on the captured image, a region in which each of the display elements is displayed, based on the display position information. Subsequently, for each of the regions in which a numerical value is displayed, the recognition unit 1541 performs character recognition. Accordingly, the recognition unit 1541 can recognize the date, the time, the measurement value, or the error code. For each of the regions in which a specific image such as the body motion mark is displayed, the recognition unit 1541 determines whether or not the display element is displayed in the region, based on comparison with the image data in the manual information. The recognition unit 1541 outputs a recognition result including, for example, a character recognition result related to the regions 221 to 226, and a flag indicating whether or not the display element corresponding to each of the regions 227 to 229 is displayed (whether or not the body motion mark is displayed, for example). Note that the recognition unit 1541 may perform image recognition using artificial intelligence (AI) technology such as a neural network.

Based on the recognition result output from the recognition unit 1541, and the display position information and the image data of each of the display elements in the manual information, the reproduction unit 1542 generates an image in which the display content displayed by the display device 220 of the blood pressure monitor 200 is reproduced. The image generated by the reproduction unit 1542 is displayed by the display device 106 as the presentation image. Since the same image as the image of the display content displayed in the blood pressure monitor 200 is displayed by the display device 106 of the terminal device 100, a user can intuitively perform an operation of selecting a display element.

Note that the presentation image generation unit 154 may extract, from the captured image, a partial image corresponding to the display content, and output this partial image as the presentation image.

The descriptive information acquisition unit 155 acquires descriptive information related to the display element selected by a user. Specifically, the descriptive information acquisition unit 155 extracts descriptive information related to the display element selected by a user, from the manual information stored in the manual information storage unit 161.

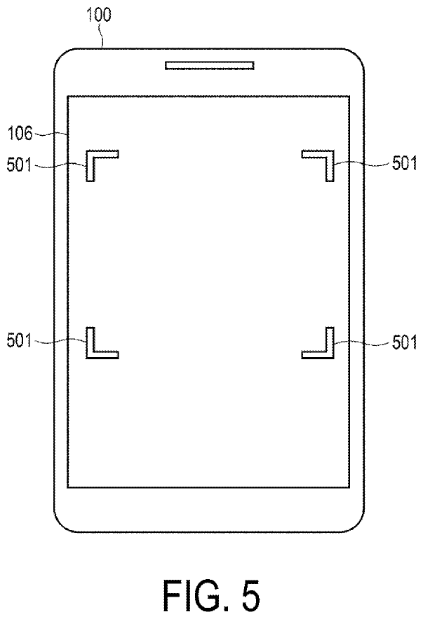

FIG. 5 illustrates an example of a guide displayed by the display device 106 in the image capture mode. As illustrated in FIG. 5, the display control unit 153 causes the display device 106 to display a frame 501 as the guide, and an image to be captured by the camera 109. In FIG. 5, the image to be captured by the camera 109 is not illustrated. A user captures an image of the blood pressure monitor 200 such that the display screen of the blood pressure monitor 200 fits within the frame 501. The frame 501 is displayed by the display device 106 in this manner, the recognition by the recognition unit 1541 can be performed easily.

FIG. 6 illustrates an example of the selection screen 600 for selecting a display element of which a user desires to learn meaning, and FIG. 7 illustrates an example of the description screen 700 for presenting descriptive information related to the display element selected by the user. The selection screen 600 illustrated in FIG. 6 is displayed by the display device 106 after a user has captured an image of the blood pressure monitor 200 by using the camera 109. The selection screen 600 includes a presentation image 601 and a message 602 that prompts a user to select a display element of which the user desires presentation of descriptive text. After the user taps any of display elements on the presentation image 601, the description screen 700 illustrated in FIG. 7 is displayed by the display device 106.

The description screen 700 includes a portion 701 of the presentation image including the display element selected by the user, and descriptive information 702 related to the display element. In the example illustrated in FIG. 7, the descriptive information 702 includes descriptive text 702A related to the display element, and a hyperlink 702B to a Web page associated with the display element. In response to a user tapping the hyperlink 702B, a browser starts and a Web page is displayed in the browser. A moving image may be embedded in a Web page. For example, a Web page associated with the cuff mark includes a moving image describing a method for attaching the cuff. Accordingly, a user can obtain more detailed description than description related to each of the display elements that is generally provided in an operation manual (an electronic manual, for example).

The description screen 700 may further include a button 703 for calling an operator. Typically, the button 703 is initially inactive, and after a user taps the hyperlink 702B, the button 703 is activated. In response to a user tapping the button 703 being in an active state, the control unit 101 of the terminal device 100 makes a call to a call center related to the blood pressure monitor 200. To prevent a user from calling an operator several times in succession, the button 703 may be deactivated until predetermined time elapses after the button 703 has been depressed once.

Note that, in the present embodiment, the example in which any of the functions of the terminal device 100 is realized by a general-purpose processor is described. However, some or all of the functions may be realized by a single or a plurality of dedicated processors.

### Operation Example

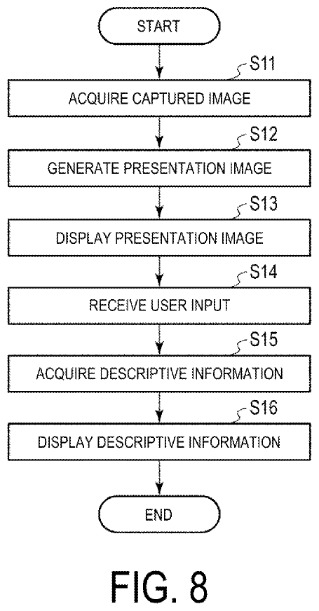

FIG. 8 illustrates an operation flow performed when the terminal device 100 provides the operation manual service.

At step S11 in FIG. 8, the control unit 101 of the terminal device 100 acquires a captured image from the camera 109. For example, a user starts operation manual application on the terminal device 100 to find out meaning of the body motion mark displayed on the display screen of the blood pressure monitor 200. When the operation manual application starts, the terminal device 100 becomes in the image capture mode. A user captures, by using the camera 109, an image of the blood pressure monitor 200 being in a state where the body motion mark is displayed on the display screen, and the camera 109 outputs the captured image to the control unit 101.

At step S12, the control unit 101 operates as the presentation image generation unit 154, and generates, based on the acquired captured image, a presentation image corresponding to display content displayed on the display screen of the blood pressure monitor 200. The presentation image includes the body motion mark. For example, the control unit 101 generates, as the presentation image, an image in which the display content displayed on the display screen of the blood pressure monitor 200 is reproduced.

At step S13, the control unit 101 operates as the first display control unit 1531, and causes the display device 106 to display the generated presentation image. For example, the control unit 101 causes the display device 106 to display a selection screen including the presentation image (the selection screen 600 illustrated in FIG. 6, for example).

At step S14, the control unit 101 operates as the input unit 152, and receives a user input indicating a display element selected by a user from among display elements in the presentation image. For example, a user touches the body motion mark displayed by the display device 106. The control unit 101 receives, from the input device 107, an operation signal according to the touch by the user, and identifies, based on the operation signal, that the display element selected by the user is the body motion mark.

At step S15, the control unit 101 operates as the descriptive information acquisition unit 155, and acquires descriptive information related to the display element selected by the user. For example, the control unit 101 extracts descriptive information associated with the body motion mark from the manual information stored in the storage unit 105.

At step S16, the control unit 101 operates as the second display control unit 1532, and causes the display device 106 to display the acquired descriptive information. For example, the control unit 101 causes the display device 106 to display a description screen including descriptive text of the body motion mark (the description screen 700 illustrated in FIG. 7, for example). The description screen may further include a hyperlink to a Web page associated with the body motion mark.

In this way, the terminal device 100 displays the descriptive information related to the display element displayed in the blood pressure monitor 200.

Note that at step S11, it is assumed that the user captures the image of the blood pressure monitor 200 such that all the display screen of the blood pressure monitor 200 fits within the frame of the camera 109. However, the image of the blood pressure monitor 200 may be captured such that only a portion of the display screen of the blood pressure monitor 200 fits within the frame. Additionally, at step S16, the descriptive text may be synthesized into voice and output through the speaker 110.

### Effects

The terminal device 100 described above generates a presentation image corresponding to display content, based on a captured image generated by the camera 109 capturing an image of the blood pressure monitor 200 being in a state where display content is displayed on a display screen, displays the presentation image by the display device 106, receives a user input indicating a display element selected by the user, acquires descriptive information including descriptive text of the display element, and displays the descriptive information by the display device 106. Accordingly, a user can obtain descriptive information related to a display element by performing a simple operation including the image capture of the blood pressure monitor 200 and the selection of a display element. In other words, a user can reach descriptive information related to a display element by a small number of procedures. Thus, a user can quickly and easily learn meaning of a display element displayed in an electronic device.

The selection of a display element is performed by touching on the touch panel. Thus, even as for a display element such as a pictogram that is difficult to express by using a keyword, description of the display element can be obtained easily.

### Modified Examples

Note that the present invention is not limited to the embodiments described above.

For example, the manual information acquisition unit 151 and the manual information storage unit 161 are not necessarily required. In an embodiment in which the manual information acquisition unit 151 and the manual information storage unit 161 are not provided, each time a terminal device 100 provides operation manual service, the terminal device 100 accesses, via the Internet, a server that holds manual information. For example, a presentation image generation unit 154 acquires, from the server via a communication interface 108, display position information and image data associated with model information, and generates a presentation image, based on the acquired display position information, the acquired image data, and a captured image. In response to an input unit 152 receiving a user input, a descriptive information acquisition unit 155 acquires, via the Internet, descriptive information related to a display element indicated by the user input. For example, the descriptive information acquisition unit 155 sends, to the server via the communication interface 108, a request signal of requesting the descriptive information related to the display element selected by a user, and receives, from the server via the communication interface 108, the descriptive information related to the display element. The descriptive information may be updated at any timing. Each time the operation manual service is provided, the descriptive information is acquired, and accordingly, the latest descriptive information can be presented to a user. Further, since it is not necessary for the terminal device 100 to hold the manual information, a storage resource can be saved.

Additionally, in a case where the terminal device 100 is configured to acquire the descriptive information via the Internet each time the operation manual service is provided, a manufacturer can understand what kind of information is requested by a user, based on a request signal collected by the server. In other words, a manufacturer can obtain information useful for improving a product (the blood pressure monitor 200 in this example). For example, in a case where descriptive information of a certain pictogram is requested by a number of users, a manufacturer determines that the pictogram is difficult for a user to understand and changes a design of the pictogram. The request signal may include information related to a user, together with information identifying a display element selected by the user. The information related to a user includes, for example, gender and/or an age of the user.

In the embodiment described above, a user inputs the model information of the blood pressure monitor 200. In an embodiment, the terminal device 100 may include a model identification unit that identifies a model of the blood pressure monitor 200 from a captured image. The model identification unit executes predetermined processing by the control unit 101 executing a program stored in the storage unit 105.

In an example, as illustrated in FIG. 2, the model information 203 is printed in the vicinity of the display screen of the blood pressure monitor 200, and a user captures an image of the blood pressure monitor 200 such that the display screen and the model information 203 fit within the frame of the camera 109. The model identification unit performs character recognition on the captured image, and accordingly identifies a model of the blood pressure monitor 200.

In another example, an identification code for identifying a model is provided on the display screen or a housing of the blood pressure monitor 200. The identification code may be, for example, a two-dimensional code. The model identification unit decodes the identification code in a captured image, and accordingly identifies a model of the blood pressure monitor 200. The identification code may include a command for starting operation manual application. In this case, when the identification code is read by the camera 109, the control unit 101 starts the operation manual application, and also identifies a model of the blood pressure monitor 200.

In yet another example, the model identification unit identifies a model of the blood pressure monitor 200, based on arrangement of a display element in a captured image. This example utilizes variation in arrangement of a display element for each model. Additionally, in yet another example, the model identification unit identifies a model of the blood pressure monitor 200 from appearance of the blood pressure monitor 200 in a captured image.

In the manual information storage unit 161, the manual information is stored in association with each of a plurality of models. The recognition unit 1541 in the presentation image generation unit 154 reads out, from the manual information storage unit 161, manual information associated with a model identified by the model identification unit described above, extracts, from a captured image, a partial image corresponding to the recognition range, and recognizes a display element displayed by a display device of an electronic device, based on comparison between the extracted partial image and image data in the read-out manual information. Then, the reproduction unit 1542 in the presentation image generation unit 154 generates a presentation image, based on a recognition result output from the recognition unit 1541.

In a case where the terminal device 100 includes the model identification unit, it is not necessary for a user to input the model information. Thus, convenience is improved for a user.

The operation manual service may be a function of health management application for recording and managing blood pressure measurement results and the like. For example, a user interface of the health management application is provided with a help button for executing the operation manual service. When a user taps the button, the processing described with reference to FIG. 8 is executed.

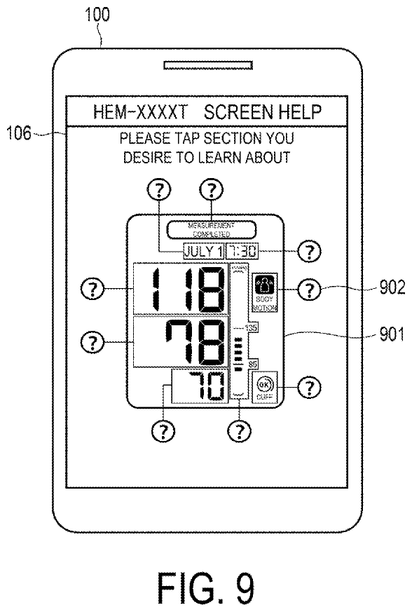

The operation of selecting a display element is not limited to the user tapping of the region on the screen corresponding to any of the display elements, as illustrated in FIG. 6. For example, as illustrated in FIG. 9, a presentation image 901 may be disposed in the center of a display screen, and a display element may be selected by tapping of a region outside the presentation image 901. For example, when a user taps a mark 902 connected to the body motion mark, the terminal device 100 presents descriptive information related to the body motion mark.

In short, the present invention is not limited to the embodiments described above as they are, and the components can be modified and embodied without departing from the gist of the present invention in a stage of implementation. Additionally, various inventions can be formed by appropriately combining a plurality of the components disclosed in the embodiment described above. For example, some of the components may be omitted from all the components described in the embodiments. Further, the components of the different embodiments may be combined appropriately.

### Supplementary Notes

A portion or all of the embodiments can also be described as described in the following supplementary notes in addition to the claims, but are not limited to this.

A terminal device (100) includes

a display device (106),

an image capture device (109) configured to capture an image of an electronic device to generate a captured image, the electronic device being in a state where display content including at least one display element is displayed on a display screen,

a presentation image generation unit (154) configured to generate, based on the captured image, a presentation image corresponding to the display content,

a first display control unit (1531) configured to cause the display device to display the presentation image,

an input unit (152) configured to receive a user input of selecting a display element in the presentation image,

a descriptive information acquisition unit (155) configured to acquire descriptive information including descriptive text of the display element, and

a second display control unit (1532) configured to cause the display device to display the descriptive text.

### REFERENCE SIGNS LIST

10 Terminal device
11 Camera
12 Touch screen
12A Display device
12B Touch panel
13 Information processing unit
20 Blood pressure monitor
21 Display screen
100 Terminal device
101 Control unit
102 CPU
103 RAM
104 ROM
105 Storage unit
106 Display device
107 Input device
108 Communication interface
109 Camera
110 Speaker
111 Microphone
112 Battery
151 Manual information acquisition unit
152 Input unit
153 Display control unit
1531 First display control unit
1532 Second display control unit
154 Presentation image generation unit
1541 Recognition unit
1542 Reproduction unit
155 Descriptive information acquisition unit
161 Manual information storage unit
200 Blood pressure monitor
201 Body
202 Brand information
203 Model information
211 to 216 Button
220 Display device

1. A terminal device comprising:
a display device;
an image capture device configured to capture an image of an electronic device to generate a captured image, the electronic device being in a state where display content including at least one display element is displayed on a display screen;
a presentation image generation unit configured to generate, based on the captured image, a presentation image corresponding to the display content;
a first display control unit configured to cause the display device to display the presentation image;
an input unit configured to receive a user input of selecting a display element in the presentation image;
a model information acquisition unit configured to acquire model information indicating a model of the electronic device;
a descriptive information acquisition unit configured to acquire descriptive information including descriptive text of the display element and associated with the model information; and
a second display control unit configured to cause the display device to display the descriptive text.

2. The terminal device according to claim 1, wherein
the display element is a pictogram.

3. The terminal device according to claim 1, wherein
the presentation image generation unit generates, as the presentation image, an image in which the display content is reproduced.

4. The terminal device according to claim 1, wherein
the descriptive information acquisition unit acquires the descriptive information via the Internet in response to the user input.

5. The terminal device according to claim 1, wherein
the model information acquisition unit includes a model identification unit configured to identify a model of the electronic device, based on a partial image corresponding to the display content in the captured image.

6. The terminal device according to claim 1, wherein
the descriptive information further includes a Uniform Resource Locator (URL) of a Web page associated with the display element, and
the second display control unit causes the display device to further display a hyperlink to the Web page.

7. An information processing method executed by a terminal device including a display device, and an image capture device configured to capture an image of an electronic device to generate a captured image, the electronic device being in a state where display content including at least one display element is displayed on a display screen, the information processing method comprising processes of:
generating, based on the captured image, a presentation image corresponding to the display content;
causing the display device to display the presentation image;
receiving a user input of selecting a display element in the presentation image;
acquiring model information indicating a model of the electronic device;
acquiring descriptive information including descriptive text of the display element and associated with the model information; and
causing the display device to display the descriptive text.

8. A non-transitory storage medium recording a program for causing a computer to function as each of units provided in the terminal device according to claim 1.
